(19) United States
(12) Patent Application Publication
(10) Pub. No.: US 2024/0039137 A1
(43) Pub. Date: Feb. 1, 2024

(54) WAVEGUIDE

(71) Applicant: NIPPON TELEGRAPH AND TELEPHONE CORPORATION, Tokyo (JP)

(72) Inventors: Hirofumi SASAKI, Tokyo (JP); Yasunori YAGI, Tokyo (JP); Doohwan LEE, Tokyo (JP); Jun MASHINO, Tokyo (JP); Takayuki YAMADA, Tokyo (JP); Tomoki SEMOTO, Tokyo (JP)

(21) Appl. No.: 18/258,955

(22) PCT Filed: Dec. 24, 2020
(86) PCT No.: PCT/JP2020/048576

§ 371 Date: Jun. 22, 2023

(51) Int. Cl. H01P 3/12

(52) U.S. Cl. CPC H01P 3/12

(57) ABSTRACT

In a waveguide, a width of the waveguide is set so that a characteristic impedance of a lowest-order mode in the waveguide varies in accordance with a predetermined function.

### TECHNICAL FIELD

The present disclosure relates to a waveguide.

### BACKGROUND ART

To realize broadband high-capacity wireless transmission using millimeter waves, terahertz waves, and the like, various spatial multiplex transmission technologies, such as a multi-input multi-output (MIMO) technology using an extremely large number of antenna elements, and an orbital angular momentum (CAM) multiplexing transmission technology, have been suggested recently (see Non Patent Literature 1, for example).

Non Patent Literature 1 discloses a technique of performing spatial multiplex transmission of different signal sequences by transmitting respective radio waves in a plurality of OAM modes generated with the use of a uniform circular array (UCA) antenna in which a plurality of antenna elements is circularly arranged at equal intervals, and a Butler matrix.

### CITATION LIST

### Non Patent Literature

Non Patent Literature 1: E. Sasaki, M. Hirabe, T. Maru, N. Zein, “Pragmatic OAM with polarization multiplexing transmission for future 5G ultra-highcapacityradio”, inproc. of EuMA2016, October 2016.

### SUMMARY OF INVENTION

### Technical Problem

In a case where conventional spatial multiplex transmission is performed by digital signal processing, an operation amount proportional to a power of the number of antennas and the bandwidth is required. Therefore, reducing the operation amount by analogizing some or all of processes is promising. In a case where analogizing is performed, however, the bandwidth might become wider due to the use of a high frequency for communication or the like, or a reflection loss in an analog circuit might become a problem.

One aspect of the present disclosure aims to provide a technique by which low reflection loss characteristics can be improved.

### Solution to Problem

A suggested solution is to provide a waveguide in which the width of the waveguide is set so that the characteristic impedance of the lowest-order mode in the waveguide varies in accordance with a predetermined function.

### Advantageous Effects of Invention

According to one aspect, low reflection loss characteristics can be improved.

### BRIEF DESCRIPTION OF DRAWINGS

FIG. 1 is a diagram for explaining an example configuration of a circuit 10 according to an embodiment.

FIG. 2 is a diagram for explaining a method for designing a waveguide 400 according to the embodiment.

FIG. 3 is a diagram for explaining an example configuration of the waveguide 400 according to the embodiment.

FIG. 4 is a diagram for explaining performance of the waveguide 400 according to the embodiment.

FIG. 5 is a diagram for explaining an example configuration of the waveguide 400 according to the embodiment.

FIG. 6 is a diagram for explaining an example configuration of the waveguide 400 according to the embodiment.

FIG. 7 is a diagram for explaining performance of the waveguide 400 according to the embodiment.

FIG. 8 is a diagram for explaining an example configuration of the waveguide 400 according to the embodiment.

FIG. 9A is a diagram for explaining a phase shifter 300 according to the embodiment.

FIG. 9B is a diagram for explaining the phase shifter 300 according to the embodiment.

FIG. 9C is a diagram for explaining the phase shifter 300 according to the embodiment.

FIG. 9D is a diagram for explaining the phase shifter 300 according to the embodiment.

FIG. 9E is a diagram for explaining the phase shifter 300 according to the embodiment.

FIG. 10A is a diagram for explaining performance of the phase shifter 300 according to the embodiment.

FIG. 10B is a diagram for explaining performance of the phase shifter 300 according to the embodiment.

FIG. 11 is a diagram for explaining an example configuration of the phase shifter 300 according to the embodiment.

FIG. 12A is a diagram for explaining the configuration of a 3 dB coupler 200 according to the embodiment.

FIG. 12B is a diagram for explaining the configuration of the 3 dB coupler 200 according to the embodiment.

FIG. 13 is a diagram for explaining performance of the 3 dB coupler 200 according to the embodiment.

FIG. 14A is a diagram for explaining the configuration of a cross coupler 500 according to the embodiment.

FIG. 14B is a diagram for explaining the configuration of the cross coupler 500 according to the embodiment.

FIG. 15 is a diagram for explaining performance of the cross coupler 500 according to the embodiment.

### DESCRIPTION OF EMBODIMENTS

The following is a description of an embodiment of the present disclosure, with reference to the drawings.

<Overall Configuration>

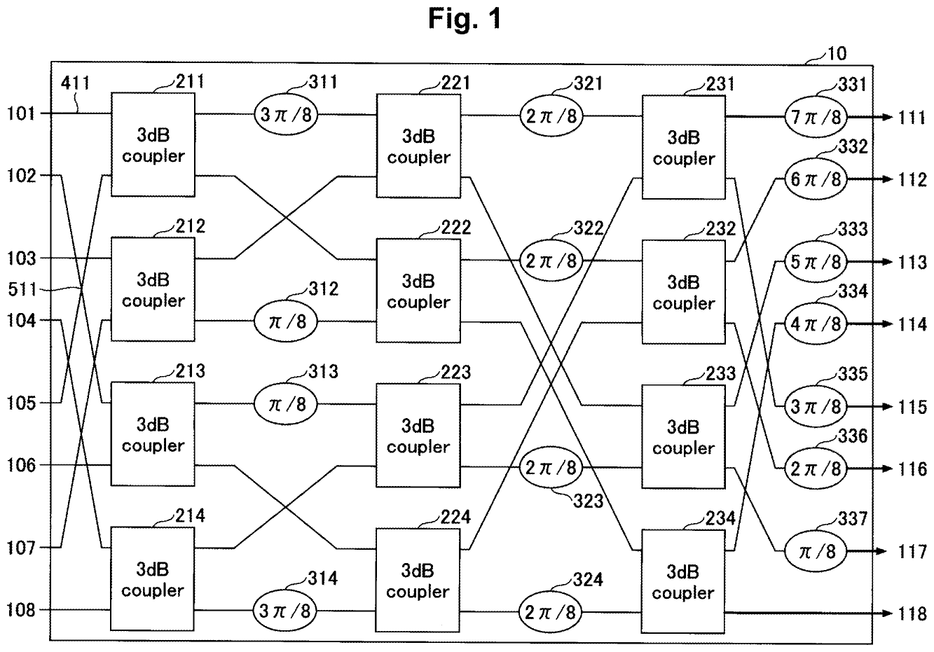

FIG. 1 is a diagram for explaining an example configuration of a circuit 10 according to an embodiment. In the example in FIG. 1, the circuit 10 is an 8×8 Butler matrix. For example, at the time of use, the circuit 10 may be connected to a uniform circular array (UCA) of a transmitter station or a receiver station that performs multiplex transmission using an orbital angular momentum (OAM) or the like. Note that waveguides (waveguides), phase shifters, 3 dB couplers, and the like of the present disclosure are not necessarily used in a Butler matrix, but can be used in a circuit for transmitting and receiving various kinds of signals.

In the example in FIG. 1, the circuit 10 includes input units (ports) 101 to 108 that receives inputs of signals, and output units (ports) 111 to 118 that output signals. The circuit also includes 3 dB couplers 211 to 214, 221 to 224, and 231 to 234 (hereinafter also referred to simply as the “3 dB couplers 200” in a case where there is no need to distinguish these couples from one another), and phase shifters 311 to 314, 321 to 324, and 331 to 337 (hereinafter also referred to as the “phase shifters 300” in a case where there is no need to distinguish these phase shifters from one another).

The 3 dB couplers 200 are devices that demultiplex and multiplex electromagnetic waves such as optical signals. The phase shifters 300 are devices that give relative phase differences to the respective paths. In the example in FIG. 1, the phase differences based on the path (waveguide) not extending through any phase shifter 300 as a reference (0) is expressed in radian.

Further, the respective input units 101 to 108 and the respective 3 dB couplers 200, the respective 3 dB couplers 200 and the other 3 dB couplers 200 or the respective phase shifters 300, the 3 dB couplers 200 or the phase shifters 300 and the respective output units 111 to 118 are connected by waveguides (waveguides) 411 and the like (hereinafter also referred to simply as the “waveguides 400”). The waveguides 400 may be hollow waveguides (rectangular waveguides) having a rectangular cross-sectional shape, for example. Alternatively, the waveguides 400 may be metal tubes (circular waveguides) having a circular cross-section.

Further, in FIG. 1, the portions at which the waveguides 400 intersect (cross) (such as a portion 511 and the like, for example) may be connected by cross couplers (hereinafter also referred to as the “cross couplers 500” as appropriate). Note that each of the 3 dB couplers 200 and the cross couplers 500 is an example of a “coupler”.

In the examples described below, the widths and/or the dielectric constants of waveguides such as the waveguides 400 and the phase shifters 300 are determined on the basis of the characteristic impedance at the angular frequency of the lowest-order mode of the waveguides. Note that the width and/or the dielectric constant of the waveguides may be determined with the use of various kinds of parameters (effective dielectric constant, for example) correlated with the characteristic impedance, instead of being directly determined with the use of the characteristic impedance. Note that the characteristic impedance in a case where a rectangular waveguide is filled with a dielectric material having a relative permittivity εᵣ is expressed by Equation (9) described later, and accordingly, the effective dielectric constant inside the waveguide having an appropriate dielectric material density can be determined from the value of the characteristic impedance by back calculation.

<Waveguide 400>

In a waveguide 400 according to the embodiment, the density of the dielectric material in the waveguide 400 and/or the width of the waveguide 400 is set (formed, processed or configured) so that the characteristic impedance of the lowest-order mode in the waveguide 400 varies with a predetermined function.

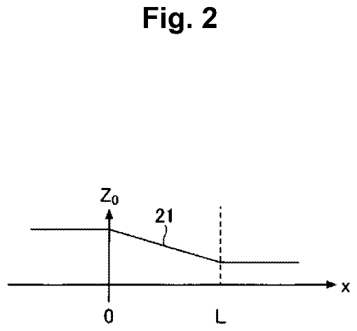

FIG. 2 is a diagram for explaining a method for designing the waveguide 400 according to the embodiment. In the example in FIG. 2, the waveguide 400 is designed so that the characteristic impedance Z_{c}(x) at the angular frequency ω_{c} of the lowest-order mode in the waveguide 400 monotonically decreases (linearly changes, for example) within a predetermined length L, where x represents the direction in which the waveguide 400 extends, as expressed in Equation (1) shown below.

$$\begin{matrix}[ Math . 1 ] & \\ {Z}_{c} ( x ) = ( \frac{{Z}_{c} ( {L}_{t} ) - {Z}_{c} ( 0 )}{{L}_{t}} ) x + {Z}_{c} ( 0 ) ( 0 \leq x \leq {L}_{t} ) & ( 1 )\end{matrix}$$

As a result, the waveguide shape or the effective dielectric constant in the waveguide can be adjusted so that the characteristic impedance of the waveguide fundamental mode changes linearly or the like, and the reflection loss at a desired frequency is minimized. Thus, the width of the waveguide and the filling medium can be converted with a low reflection loss over a wide band.

(Example in which the Density or the Like of the Dielectric Material in the Waveguide 400 is Varied)

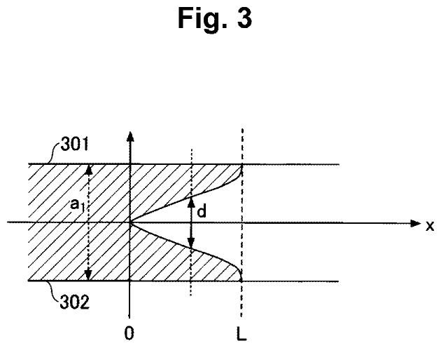

FIG. 3 is a diagram for explaining an example configuration of the waveguide 400 according to the embodiment. FIG. 3 shows an example cross-sectional view of the waveguide 400 in a case where the dielectric constant inside the waveguide 400 is varied so as to achieve the characteristic impedance illustrated in FIG. 2 described above. In the example in FIG. 3, the dielectric material that fills the waveguide 400 is processed to form an air layer having an appropriate shape, and vary the effective dielectric constant with respect to electromagnetic waves.

The example in FIG. 3 illustrates metal walls 301 and 302 in the cross-sectional view of the waveguide 400, the inner width (the inner height, or the inner diameter, for example) a₁ of the waveguide 400, and the diameter d of the hollow portion inside the waveguide 400, which is not filled with a dielectric material. Note that the center of the diameter d of the hollow portion is the same as the center of the inner width a₁ of the waveguide 400.

Also, in the example in FIG. 3, the diameter d and the predetermined length L at each position x in the direction in which the waveguide 400 extends are determined on the basis of Equation (2) shown below. Note that, in the description below, ω_{c} represents the angular frequency, μ₀ represents the permeability in vacuum, ε_{Y} represents the relative permittivity of the dielectric material, and k₀ represents the wavenumber in vacuum. With this, the length (predetermined length L) of the portion in which the characteristic impedance Z_{c}(x) at the angular frequency ω_{c} varies is determined so as to be non-reflective at a predetermined frequency.

$$\begin{matrix}[ Math . 2 ] & \\ x = ( \frac{{L}_{t}}{{Z}_{c} ( {L}_{t} ) - {Z}_{c} ( 0 )} ) [ {ω}_{c} {μ}_{0} {\{ {ε}_{r} {k}_{0}^{2} - {( \frac{π}{{a}_{1}} )}^{2} - {k}_{0}^{2} ( {ε}_{r} - 1 ) \{ \frac{d}{{d}_{1}} + \frac{1}{π} sin ( π \frac{d}{{d}_{1}} ) \} \}}^{- 1 / 2} - {Z}_{c} ( 0 ) ] & ( 2 )\end{matrix}$$

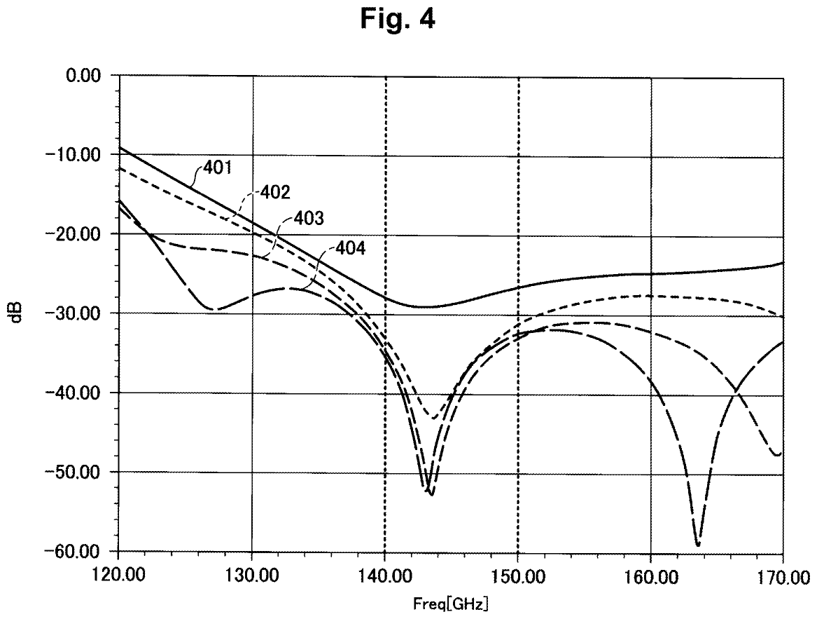

FIG. 4 is a diagram for explaining the performance of the waveguide 400 according to the embodiment. FIG. 4 illustrates results of electromagnetic field analysis of the attenuance at each frequency at each value of L, with the abscissa axis indicating the frequency (GHz) of a signal being transmitted in the waveguide 400 illustrated in FIG. 3, the ordinate axis indicating the attenuance (reflection loss (dB)) of the signal. Curves 401 to 404 indicate the results of the electromagnetic field analysis of the attenuance at each frequency at each value of L determined by setting a natural number m to m=1, 2, 3, and 4 in Equation (3) shown below. Note that Equation (3) indicates the conditions under which the length or the like of the portion in which the inner width a of the waveguide such as the waveguide 400 varies becomes non-reflective at a predetermined frequency.

$$\begin{matrix}[ Math . 3 ] & \\ {L}_{t} = \frac{m π}{{ω}_{c} {μ}_{0}} \times \frac{{Z}_{c} ( 0 ) - {Z}_{c} ( {L}_{t} )}{log ( {Z}_{c} ( 0 ) / {Z}_{c} ( {L}_{t} ) )} & ( 3 )\end{matrix}$$

FIG. 4 shows the following trade-offs: where the value of m is greater, the performance is better, but the predetermined length L is longer.

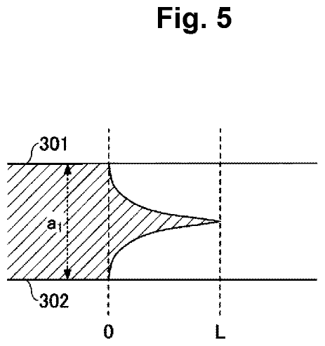

FIG. 5 is a diagram for explaining an example configuration of the waveguide 400 according to the embodiment. FIG. 5 shows another example cross-sectional view of the waveguide 400 in a case where the dielectric constant inside the waveguide 400 is varied so as to achieve the characteristic impedance illustrated in FIG. 2 described above.

(Example in which the Inner Width of the Waveguide 400 is Varied)

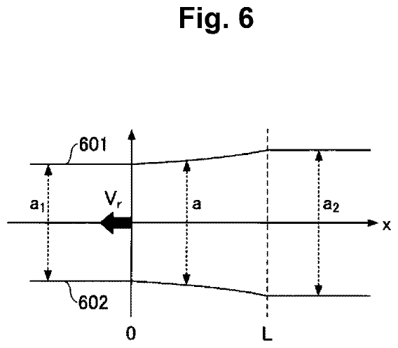

FIG. 6 is a diagram for explaining an example configuration of the waveguide 400 according to the embodiment. FIG. 6 shows an example cross-sectional view of the waveguide 400 in a case where the inner width of the waveguide 400 is varied so as to achieve the characteristic impedance illustrated in FIG. 2 described above. In the example in FIG. 6, the width of the waveguide is varied in accordance with a predetermined function.

The example in FIG. 6 illustrates metal walls 601 and 602 in the cross-sectional view of the waveguide 400, the original inner width a₁ of the waveguide 400, and the inner width a₂ after the inner width a changes at the predetermined length L.

Also, in the example in FIG. 6, the inner width a at each position x in the direction in which the waveguide 400 extends is determined on the basis of Equation (4) shown below.

$$\begin{matrix}[ Math . 4 ] & \\ a = π {\{ {ε}_{r} {k}_{0}^{2} - {( \frac{{ω}_{c} {μ}_{0}}{{Z}_{c} ( x )} )}^{2} \}}^{- 1 / 2} & ( 4 )\end{matrix}$$

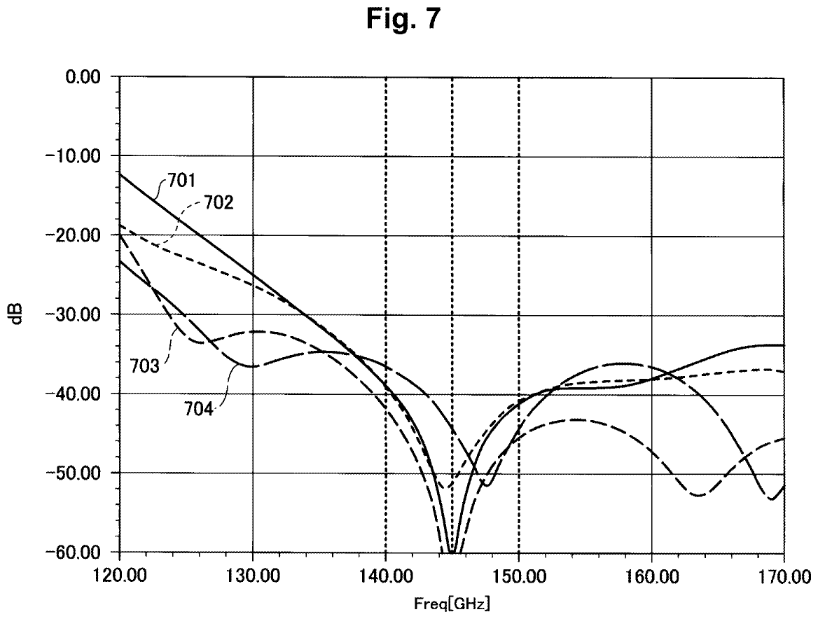

FIG. 7 is a diagram for explaining the performance of the waveguide 400 according to the embodiment. FIG. 7 illustrates results of electromagnetic field analysis of the attenuance at each frequency at each value of L, with the abscissa axis indicating the frequency (GHz) of a signal being transmitted in the waveguide 400 illustrated in FIG. 6, the ordinate axis indicating the attenuance (reflection loss (dB)) of the signal. Curves 701 to 704 indicate the results of the electromagnetic field analysis of the attenuance at each frequency at each value of L determined by setting a natural number m to m=1, 2, 3, and 4 in Equation (3) shown above.

(Example in which the Density or the Like of the Dielectric Material in the Waveguide 400 and the Inner Width of the Waveguide 400 are Varied)

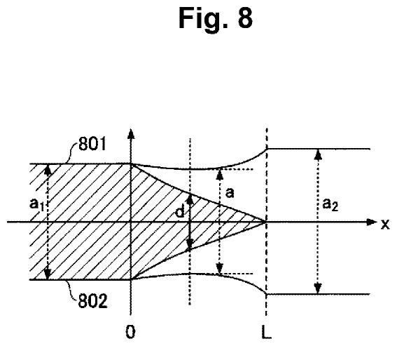

FIG. 8 is a diagram for explaining an example configuration of the waveguide 400 according to the embodiment. FIG. 8 shows an example cross-sectional view of the waveguide 400 in a case where the density or the like of the dielectric material in the waveguide 400 and the inner width of the waveguide 400 are varied so as to achieve the characteristic impedance illustrated in FIG. 2 described above.

The example in FIG. 8 illustrates metal walls 801 and 802 in the cross-sectional view of the waveguide 400, the original inner width a₁ of the waveguide 400, the inner width a₂ after the inner width a changes at the predetermined length L, and the diameter d of the filled portion filled with the dielectric material inside the waveguide 400. Note that the center of the diameter d of the filled portion is the same as the center of the inner widths a₁ and a₂ of the waveguide 400.

Also, in the example in FIG. 8, the inner width a at each position x in the direction in which the waveguide 400 extends is determined on the basis of Equations (5), (6), and (7) shown below.

$$\begin{matrix}[ Math . 5 ] & \\ x = {tL}_{t} ( 0 \leq t \leq 1 ) & ( 5 )\end{matrix}$$

$$\begin{matrix}[ Math . 6 ] & \\ a ( q ) = π {\{ {k}_{0}^{2} - {( \frac{{ω}_{c} {μ}_{0}}{{Z}_{c} ( {tL}_{t} )} )}^{2} + {k}_{0}^{2} ( {ε}_{r} - 1 ) \{ f ( q ) + \frac{1}{π} sin ( π f ( q ) ) \} \}}^{- 1 / 2} & ( 6 )\end{matrix}$$

$$\begin{matrix}[ Math . 7 ] & \\ d ( q ) = f ( q ) \times a ( q ) & ( 7 )\end{matrix}$$

Note that f(q) in Equation (7) may be any function that monotonically decreases from 1 to 0. In that case, f(q) in Equation (7) may be a function as in Equation (8) shown below. Note that the example illustrated in FIG. 8 is an example case where p=1 in Equation (8).

[Math. 8]

f(q)=(1−t)^{p} (0≤t≤1) (8)

<Phase Shifter 300>

In a phase shifter 300 according to the embodiment, the width of the phase shifter 300 (the inner width of the phase shifter 300) and/or the density of the dielectric material in the phase shifter 300 is set (formed, processed or configured) so that the characteristic impedance of the lowest-order mode in the phase shifter varies with a predetermined function.

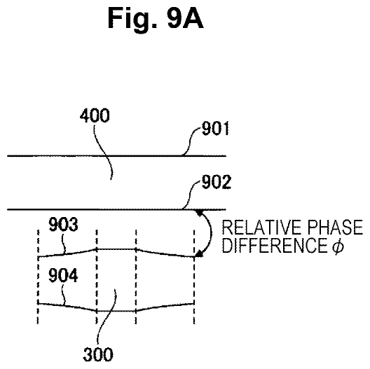

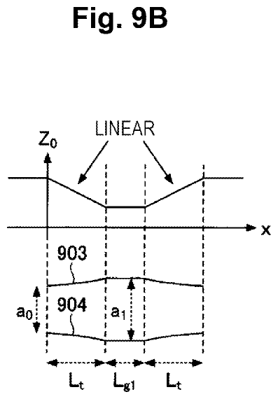

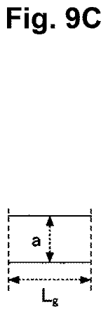

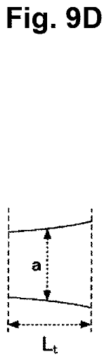

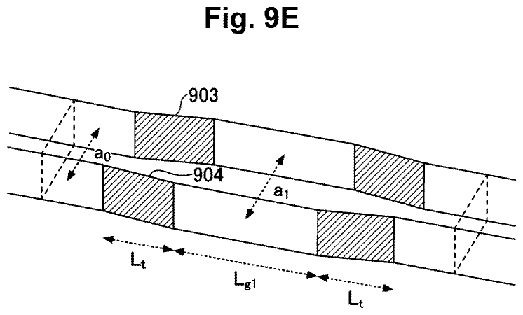

FIG. 9A is a diagram for explaining the phase shifter 300 according to the embodiment. The example in FIG. 9A shows a cross-sectional view of a waveguide 400 to be subjected to a relative phase difference φ by the phase shifter 300, and the phase shifter 300 disposed in the waveguide 400. In the example in FIG. 9A, the waveguide 400 has metal walls 901 and 902, and the phase shifter 300 has metal walls 903 and 904. The phase shifter 300 shifts the phase of the signal being guided in the phase shifter 300 by cp. Accordingly, the phase difference (relative phase difference) between the phase of the signal being guided in the phase shifter 300 and the phase of the signal being guided in the waveguide 400 is φ.

(Example in which the Inner Width of the Phase Shifter 300 is Varied)

FIGS. 9B, 9C, 9D, and 9E are diagrams for explaining the phase shifter 300 according to the embodiment. The upper portion of FIG. 9B, and FIGS. 9C and 9D are diagrams for explaining the method for designing the phase shifter 300 according to the embodiment. The lower portion of FIG. 9B and FIG. 9E illustrate an example configuration of the phase shifter 300 according to the embodiment. The lower portion of FIG. 9B illustrates an example cross-sectional view of the phase shifter 300, and FIG. 9E three-dimensionally illustrates a cross-section of the phase shifter 300.

In the example in FIG. 9B, the phase shifter 300 is designed so that the characteristic impedance Z_{c}(x) of the fundamental mode (lowest-order mode) in the phase shifter 300 (waveguide) monotonically decreases (linearly changes, for example) within a predetermined length Lₜ of a first portion in which the inner width of the phase shifter 300 changes between a₀ (the initial value of the inner width of the waveguide, for example) and a₁, and monotonically increases (linearly changes, for example) within the predetermined length Lₜ of a second portion in which the inner width changes between a₁ and a₀, with x representing the direction in which the phase shifter 300 extends. Thus, the reflection loss in the waveguide in the phase shifter 300 can be reduced, for example.

The phase shift amount of the waveguide 400 to be subjected to the relative phase difference φ by the phase shifter 300 is represented by φ_{g0}, the phase shift amount of the first portion and the second portion of the phase shifter 300 is represented by φₜ, and the phase shift amount of a third portion that is interposed between the first portion and the second portion, and has a constant width a₁ is represented by φ_{g1}. Note that the respective phase shift amounts φ_{g0}, φₜ, and φ_{g1} are functions for the respective frequencies ω in the respective portions and the respective variables related to the waveguide structure.

As illustrated in FIG. 9B, the characteristic impedance Z_{c}(x) monotonically decreases in the first portion and monotonically increases in the second portion, and the variables related to the waveguide structure are then determined according to Equation (9) shown below. Thus, a desired phase difference can be obtained while the reflection loss over a wide band is reduced, for example.

$$\begin{matrix}[ Math . 9 ] & \\ {Z}_{0} ( ω , x ) = \frac{{ωμ}_{0}}{\sqrt{{{ε}_{r} ( \frac{ω}{c} )}^{2} - {( \frac{π}{a} )}^{2}}} & ( 9 )\end{matrix}$$

Meanwhile, the phase shift amount φg of the waveguide 400 (linear waveguide) having a constant inner width in FIG. 9C is expressed by Equation (9) and Equation (10) shown below.

$$\begin{matrix}[ Math . 10 ] & \\ {φ}_{g} ( ω ) = \frac{{ωμ}_{0} {L}_{g}}{{Z}_{0} ( ω , x )} & ( 10 )\end{matrix}$$

Further, the phase shift amount φₜ in the first portion and the second portion (tapered portions) in which the inner width changes in FIG. 9D is expressed by Equation (9) and Equation (11) shown below.

$$\begin{matrix}[ Math . 11 ] & \\ {φ}_{t} ( ω ) = {ωμ}_{0} {L}_{t} \frac{log ( {Z}_{0} ( ω , {L}_{t} ) / {Z}_{0} ( ω , 0 ) )}{{Z}_{0} ( ω , {L}_{t} ) - {Z}_{0} ( ω , 0 )} & ( 11 )\end{matrix}$$

Furthermore, in Equation (12) shown below, the respective phase shift amounts φ_{g0}, φₜ, and φ_{g1} are specifically expressed by the respective variables (L_{g0}, L_{g1}, and a₁) regarding the waveguide structure. Note that L_{g0} represents the length of the waveguide 400 to be subjected to the relative phase difference φ by the phase shifter 300.

$$\begin{matrix}[ Math . 12 ] & \\ \{ \begin{matrix}{φ}_{g 0} ( {ω}_{c} ) = 2 {φ}_{t} ( {ω}_{c} ) + {φ}_{g 1} ( {ω}_{c} ) + {φ}_{s} \\ \frac{\partial {φ}_{g 0}}{\partial ω} ( {ω}_{c} ) = 2 \frac{\partial {φ}_{t}}{\partial ω} ( {ω}_{c} ) + \frac{\partial {φ}_{g 1}}{\partial ω} ( {ω}_{c} )\end{matrix} & ( 12 )\end{matrix}$$

According to Equation (12), the waveguide width in the phase shifter 300 can be varied so that the relative phase difference at the center frequency in each waveguide and the gradient of the dispersion curve become uniform between the two waveguides (the phase shifter 300 and the waveguide 400 in FIG. 9A). Thus, a desired phase difference can be obtained while the reflection loss in the waveguide is reduced over a wide band.

Note that φₛ in the upper equation of Equation (12) represents the relative phase difference (φ in FIG. 9A) caused by the phase shifter 300. Equation (12) is solved to determine L_{g0}, L_{g1}, and a₁, with φₛ being a desired phase difference (3π/8 in the case of the phase shifter 311 in FIG. 1, for example). Since a₁ and L_{g1} are in a trade-off relationship in which a₁ increases as L_{g1} decreases, for example, a₁ or L_{g1} may be fixed (set as a constant in advance) depending on the restriction of the size of the desired phase shifter 300, and Equation (12) may then be solved. In this case, the simultaneous equations of Equation (12) may be solved with respect to the two variables L_{g0} and a₁, with L_{g1} being set to 0 or the like, for example.

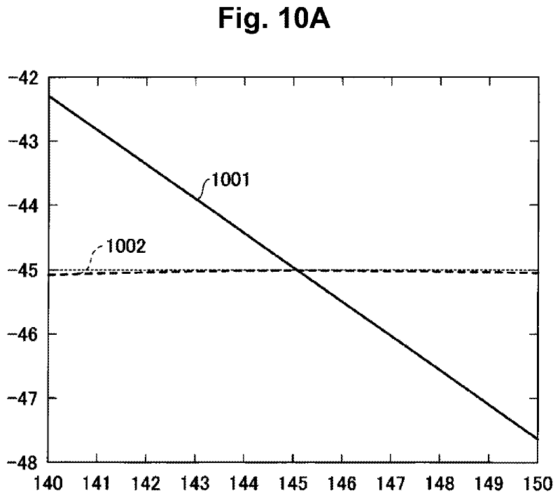

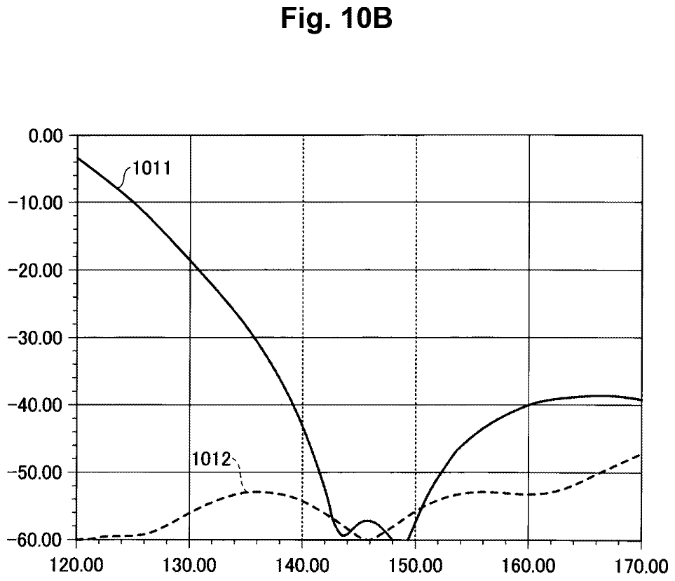

FIGS. 10A and 10B are diagrams for explaining the performance of the phase shifter 300 according to the embodiment. FIG. 10 A illustrates results of electromagnetic field analysis of an error 1002 between a relative phase difference 1001 at each frequency and a desired relative phase difference in a case where L_{g1}=1 mm, and a₁=1.6 mm, with the abscissa axis indicating the frequency (GHz) of the signal being transmitted in the phase shifter 300 illustrated in the lower portion of FIG. 9B, the ordinate axis indicating the relative phase difference (degree). Also, FIG. 10B illustrates results of electromagnetic field analysis of the attenuance, with the abscissa axis indicating the frequency (GHz) of a signal being transmitted in the phase shifter 300 illustrated in the lower portion of FIG. 9B, the ordinate axis indicating the attenuance (reflection loss (dB)) of the signal. Curves 1011 and 1012 indicate the results of the electromagnetic field analysis of the attenuance at each frequency at each value of Lₜ determined by setting a natural number m to m=1 and 3 in Equation (9).

(Example in which the Density or the Like of the Dielectric Material in the Phase Shifter 300 is Varied)

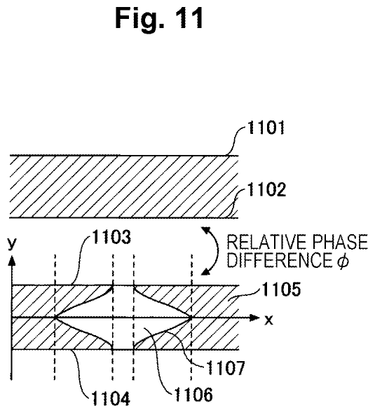

FIG. 11 is a diagram for explaining an example configuration of the phase shifter 300 according to the embodiment. In the example in FIG. 11, the waveguide 400 has metal walls 1101 and 1102, and the inside of the waveguide 400 is filled with a predetermined dielectric material. The phase shifter 300 also has metal walls 1103 and 1104, a region 1106 inside the phase shifter 300 is hollow (filled with air), and the other region 1107 is filled with a predetermined dielectric material. The phase shifter 300 shifts the phase of the signal being guided in the phase shifter 300 by φ, as in the example illustrated in FIG. 9B. Accordingly, the phase difference (relative phase difference) between the phase of the signal being guided in the phase shifter 300 and the phase of the signal being guided in the waveguide 400 is φ.

In the example in FIG. 11, the phase shifter 300 is designed so that the characteristic impedance Z_{c}(x) of the fundamental mode (lowest-order mode) in the phase shifter 300 (waveguide) monotonically decreases (linearly changes, for example) within the predetermined length Lt of the first portion, and monotonically increases (linearly changes, for example) within the predetermined length Lt of the second portion, with x representing the direction in which the phase shifter 300 extends, as in the drawing in the upper portion of FIG. 9B. Thus, the reflection loss in the waveguide in the phase shifter 300 can be reduced, for example.

Further, with the use of Equations (8) to (12) described above, the dielectric material density in the phase shifter 300 can be varied so that the relative phase difference at the center frequency in each waveguide and the gradient of the dispersion curve become uniform between the two waveguides (the phase shifter 300 and the waveguide 400), while the inner width of the phase shifter 300 is made constant (invariable). Thus, a desired phase difference can be obtained while the reflection loss in the waveguide is reduced over a wide band.

<3 dB Coupler 200>

In a 3 dB coupler 200 according to the embodiment, the density of the dielectric material in the coupled portion between a first waveguide and a second waveguide arranged in parallel varies. Therefore, a signal input to the input unit of the first waveguide is equally divided and output to the output unit of the first waveguide and the output unit of the second waveguide, and a signal input to the input unit of the second waveguide is equally divided and output to the output unit of the first waveguide and the output unit of the second waveguide. Thus, desired transmission power distribution and transmission phase characteristics can be obtained while the reflection loss is reduced over a wide band.

More specifically, in the 3 dB coupler 200 according to the embodiment, a coupled portion of a plurality of waveguides filled with a dielectric material (dielectric-material-filled waveguides) has the dielectric material processed or is filled with another dielectric material or the like, so that the dielectric material density (effective dielectric constant) varies. In this manner, the amount of coupling between waveguides arranged in parallel is adjusted. Thus, the degree of freedom in circuit design can be increased, and more preferred low reflection loss characteristics, transmission power, and phase characteristics can be obtained over a wide band, for example.

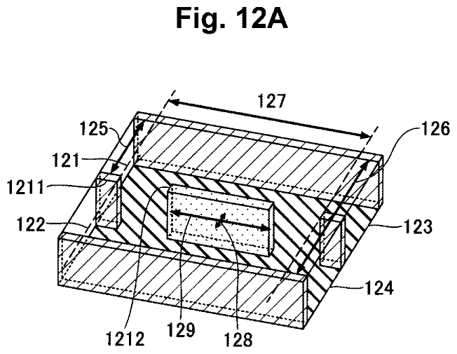

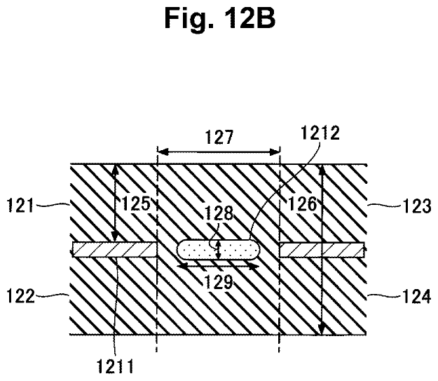

In the example described below, the dielectric material filling the waveguide is processed to form a hollow portion (an air layer or a through hole) having a predetermined shape, and the effective dielectric constant relative to electromagnetic waves is varied. FIGS. 12A and 12B are diagrams for explaining the configuration of the 3 dB coupler 200 according to the embodiment. FIG. 12A three-dimensionally illustrates a cross-section of the 3 dB coupler 200 according to the embodiment. FIG. 12B shows a cross-sectional view of the 3 dB coupler 200 according to the embodiment.

In the example in FIGS. 12A and 12B, the inside of the 3 dB coupler 200 is filled with a dielectric material. Also, input units 121 and 122 and output units 123 and 124 are provided in the 3 dB coupler 200. A signal input through the input unit 121 is equally divided and output to the output unit 123 and the output unit 124. A signal input through the input unit 122 is equally divided and output to the output unit 123 and the output unit 124.

FIGS. 12A and 12B illustrate the width 125 from the end in the width direction to a metal wall 1211, and the width 126 from one end to the other end in the width direction in the 3 dB coupler 200. The metal wall 1211 extending parallel to the direction in which the 3 dB coupler 200 extends is disposed between the input unit 121 and the input unit 122, and between the output unit 123 and the output unit 124. The metal wall 1211 has a gap of a predetermined length 127, and a hollow portion 1212 that extends parallel to the extending direction of the 3 dB coupler 200 and has a width 128 and a length 129 is disposed in the gap. Note that the center position of the hollow portion 1212 in the width direction (a direction perpendicular to the direction in which the 3 dB coupler 200 extends) may be the same as the center position of the metal wall 1211 in the width direction (the center position of the 3 dB coupler 200 in the width direction). In the example in FIGS. 12A and 12B, the hollow portion 1212 has a symmetrical shape in a plane perpendicular to the direction in which the 3 dB coupler 200 extends (the direction in which signals propagate).

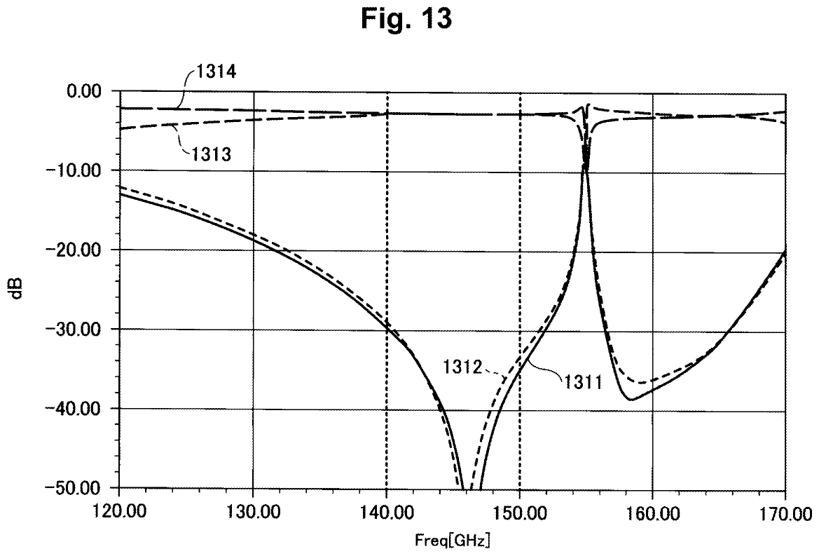

Here, for example, the width 125 may be 1.0 mm, the width 126 may be 2.1 mm, the predetermined length 127 may be 2.0 mm, the length 129 may be 1.0 mm, the width 128 may be 0.1 mm, and a dielectric material having a dielectric constant of 2.1 may be used. FIG. 13 is a diagram for explaining the performance of the 3 dB coupler 200 according to the embodiment. FIG. 13 illustrates an example of attenuances 1313 and 1314 due to branching at each frequency, and attenuances 1311 and 1312 at each frequency, with the abscissa axis indicating the frequency (GHz) of the signal being transmitted in the 3 dB coupler 200, the ordinate axis indicating the attenuance (dB) of the signal.

The attenuance 1311 indicates the attenuance of the power of a signal that is input through the input unit 121 and is output through the input unit 121. Also, the attenuance 1312 indicates the attenuance of the power of a signal that is input through the input unit 121 and is output through the input unit 122. Further, the attenuance 1314 indicates the attenuance of the power of a signal that is input through the input unit 121 and is output through the output unit 123. Further, the attenuance 1313 indicates the attenuance of the power of a signal that is input through the input unit 121 and is output through the output unit 124. The example in FIG. 13 shows that, at 140 to 150 GHz, which is the desired frequency band, the reflection loss is small and is close to −3 dB so that an input signal is equally distributed to each output.

<Cross Coupler 500>

In a cross coupler 500 according to the embodiment, the density of the dielectric material in the coupled portion between a first waveguide and a second waveguide arranged in parallel varies. Therefore, a signal input to the input unit of the first waveguide is output only to the output unit of the second waveguide, and a signal input to the input unit of the second waveguide is output only to the output unit of the first waveguide. Thus, desired transmission power distribution and transmission phase characteristics can be obtained while the reflection loss is reduced over a wide band.

More specifically, in the cross coupler 500 according to the embodiment, a coupled portion of a plurality of waveguides filled with a dielectric material (dielectric-material-filled waveguides) has the dielectric material processed or is filled with another dielectric material or the like, so that the dielectric material density (effective dielectric constant) varies, as in the 3 dB coupler 200 described above. In this manner, the amount of coupling between waveguides arranged in parallel is adjusted. Thus, the degree of freedom in circuit design can be increased, and more preferred low reflection loss characteristics, transmission power, and phase characteristics can be obtained over a wide band, for example.

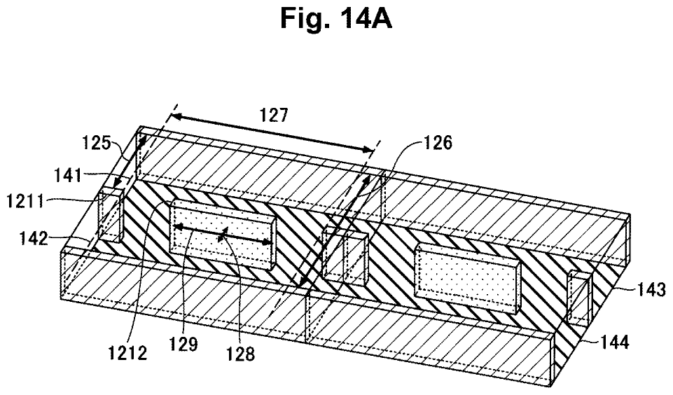

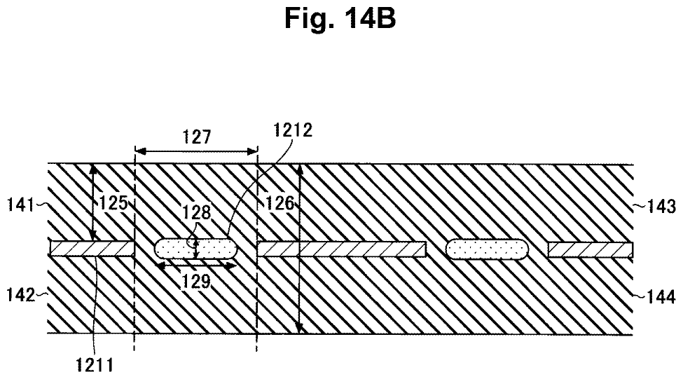

FIGS. 14A and 14B are diagrams for explaining the configuration of the cross coupler 500 according to the embodiment. FIG. 14A three-dimensionally illustrates a cross-section of the cross coupler 500 according to the embodiment. FIG. 14B shows a cross-sectional view of the cross coupler 500 according to the embodiment.

In the example in FIGS. 14A and 14B, two 3 dB couplers 200 that are the same as that described in FIGS. 12A and 12B are joined. Also, input units 141 and 142 and output units 143 and 144 are provided in the 3 dB couplers 200. A signal input through the input unit 141 is output only through the output unit 144. Also, a signal input through the input unit 142 is output only through the output unit 143.

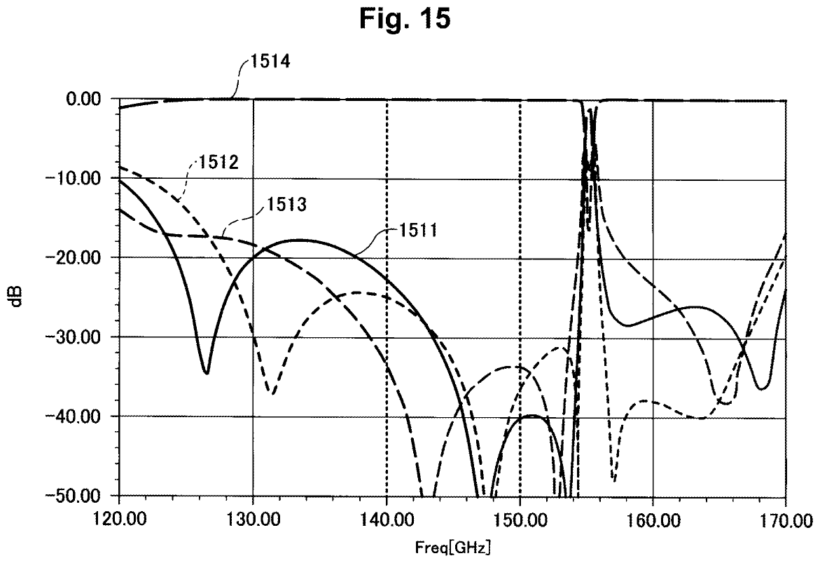

FIG. 15 is a diagram for explaining the performance of the cross coupler 500 according to the embodiment. FIG. 15 illustrates an example of an attenuance 1514 due to crossing at each frequency, and attenuances 1511, 1512, and 1513 at each frequency, with the abscissa axis indicating the frequency (GHz) of the signal being transmitted in the cross coupler 500, the ordinate axis indicating the attenuance (dB) of the signal.

Although an embodiment of the present invention has been described in detail so far, the present invention is not limited to this specific embodiment, and various modifications and changes can be made to it within the scope of the present invention disclosed in the claims.

### REFERENCE SIGNS LIST

10 circuit
200 3 dB coupler
300 phase shifter
400 waveguide
500 cross coupler

1. A waveguide comprising:
a waveguide structure including a width,
wherein the width of the waveguide structure is set so that a characteristic impedance of a lowest-order mode in the waveguide structure varies in accordance with a predetermined function.

2. The waveguide according to claim 1, wherein the width of the waveguide structure is set so that the characteristic impedance of the lowest-order mode in the waveguide monotonically decreases.

3. The waveguide according to claim 1, wherein the waveguide structure includes a dielectric material, and
wherein the width of the waveguide structure and density of the dielectric material in the waveguide structure are set so that the characteristic impedance of the lowest-order mode in the waveguide monotonically decreases.

4. The waveguide according to claim 1, wherein a length of a portion of the waveguide structure at which the density of the dielectric material varies is determined so as to be non-reflective at a predetermined frequency.
